(19) United States
(12) Patent Application Publication
(10) Pub. No.: US 2022/0238061 A1
(43) Pub. Date: Jul. 28, 2022

(54) ELECTRONIC PAPER DISPLAY SYSTEM

(71) Applicant: Fenoto Technologies Inc., Calgary (CA)

(72) Inventors: Adam Ryan McDaniel, Calgary (CA); Charles Alfred Bean, Calgary (CA)

(21) Appl. No.: 17/611,790

(22) PCT Filed: May 15, 2020
(86) PCT No.: PCT/CA2020/050659

§ 371 Date: Nov. 16, 2021

Related U.S. Application Data
(60) Provisional application No. 62/849,281, filed on May 17, 2019.

(51) Int. Cl. G09G 3/20

(52) U.S. Cl. CPC G09G 3/2092; G09G 2358/00; G09G 2370/022; G09G 2380/06; G09G 2330/023; G09G 2354/00

(57) ABSTRACT

Various implementations of an electronic paper display system and related processes are provided. The system includes a battery powered electronic paper display device containing a first processor module, and, remotely located to the electronic paper display device, a second processor module. The second processor module is configured to retrieve image content from an image source, and to render image data from the image content. The second processor module is further configured to transmit the rendered image data to the first processor module which is configured to then display an image page corresponding with the rendered image content on a display of the electronic paper device. Additionally, one or more input devices can be included in the system to enable a user to control the display of image content on the display of the electronic paper device.

### RELATED APPLICATION

This application claims the benefit of U.S. Provisional Patent Application No. 62/849,281 filed May 17, 2019; the entire contents of Patent Application 62/849,281 is hereby incorporated by reference.

### FIELD OF THE DISCLOSURE

The present disclosure relates to electronic paper display systems and processes for operating electronic paper display systems.

### BACKGROUND OF THE DISCLOSURE

The following paragraphs are provided by way of background to the present disclosure. They are not, however, an admission that anything discussed therein is prior art or part of the knowledge of persons skilled in the art.

Electronic paper, also known as e-paper, represents a development in display technology for use in, for example, mobile devices and as such can be an alternative to more traditional display technologies, such as liquid crystal diode (LCD) or organic light emitting diode (OLED) based technologies. Known examples of e-paper displays are those used by electronic books (e-books), electronic papers and electronic tags. E-paper displays are further also known to the art to be useful in signage, for example, when implemented in the form of electronic billboards.

In general, e-paper displays consume significantly less power for operation than is required in, for example, the operation of LCD or OLED displays. The primary reason for this is that e-paper displays can display a pixilated static image on a display screen without requiring a continuous supply of power, and in that sense, an e-paper display can be said to be similar to real paper.

Power is generally required to effect a change in displayed images, for example, to update the date on a calendar displayed on an e-paper display screen. The power to operate e-paper displays is commonly supplied by a battery installed in the e-paper display housing. Thus, the available battery power supplied by the installed battery generally determines the period of time during which no charges from an external power source or a change of battery is required for the e-paper display to continue to function. Despite the limited power required to operate e-paper displays, it is desirable to even further extend the time period during which no battery recharges are required, for example, to operate e-paper displays used for outdoor operation, or in other instances where an external power source may not be as readily available or practical to implement.

Therefore, there exists in the art a need for e-paper display systems that requires fewer battery recharges and are suitable for longer periods of use than the systems known to the art.

### SUMMARY OF THE DISCLOSURE

The following paragraphs are intended to introduce the reader to the more detailed description that follows and not to define or limit the claimed subject matter of the present disclosure.

In one broad aspect, the present disclosure relates to electronic paper display systems and processes for operating such systems. Accordingly, the present disclosure provides, in at least one aspect, in at least one implementation, an electronic paper display system comprising:
an electronic paper display device comprising a housing containing:
   an electronic paper display panel configured to display an image page;
   a display driver module coupled to the electronic paper display panel to drive the electronic paper display panel to display rendered image data on the image page; and
   a first processor module coupled to the display driver, the first processor module being configured to receive the rendered image data and to output the rendered image data to the display driver module; and
a remotely located second processor module separate from the electronic paper display device and coupled to the first processor module, the second processor module being configured to receive image content in the form of image content data transmitted thereto by an image content source, to generate the rendered image data based on the received image content data and to transmit the rendered image data to the first processor module.

In at least one implementation, the second processor module can be cloud-based.

In at least one implementation, the housing can further contain a battery that is configured to provide power for the electronic paper display device.

In at least one implementation, the second processor module alone, or the second processor module and the first processor module together can be configured to compare the rendered image data with existent rendered image data used to display an existent image page on the electronic paper display panel, and transmit the rendered image data to the first processor module when the rendered image data is different from the existent rendered image data used to display the existent image page.

In at least one implementation, the electronic paper display system further can be configured to communicate with one or more input devices that each comprise an input display and are configured to receive a first input from one or more users for selecting image content from the image content source, and the second processor module is configured to: (a) retrieve the selected image content in the form of image content data from the image content source and send the retrieved selected image content data to the one or more input devices for display thereon in the form of displayed image content; and (b) modify the selected image content data when an image content modification input is received from the one or more input devices and transmit the modified selected image content data for display in the form of displayed modified image content on the input display of the one or more input devices.

In at least one implementation, the second processor module can be configured to: (a) receive user image content in the form of user image content data from at least one user of one or more input devices, (b) render the user image content data to form rendered user image content data, and (c) send the rendered user image data to the first processor module which then drives the display driver module to replace the existent image page on the display panel to replace the existent image page on the electronic paper display panel with an image page corresponding with the rendered user image content.

In at least one implementation, the second processor module can be configured to display image content on an input display of one or more input devices that are communicatively coupled to the system where the image content corresponds with an existent image page displayed on the display of the electronic paper display panel, and the second processor module is further configured to (a) receive user input for modifying image content data corresponding with image content on the one or more input devices, (b) modify the image content data, (c) render image data corresponding with the modified image content data, and (d) transmit the rendered image data to the first processor module, and wherein the first processor module is configured to replace the existent image page on the electronic paper display panel with an image page corresponding with the modified image content.

In at least one implementation, the second processor module can be configured to display the image content on the input display of at least first and second input devices corresponding with an existent image page displayed on the electronic paper display panel, and the second processor module is further configured to: (a) receive user input for modifying image content data corresponding with the displayed image content on one or more of the input devices, (b) modify the displayed image content data, (c) render the modified displayed image content data and (d) transmit the rendered modified image content data to the first processor module, and the first processor module is configured to send the rendered modified image content data to the display driver module for driving the electronic paper display panel to display a modified image page corresponding with the modified image content, and the first and second processor modules are further configured to transmit the modified image content data to the at least one first and second input devices to for display of the modified image content thereat.

In at least one implementation, the first processor module can be configured to periodically transmit a triggering signal instructing the second processor module to retrieve the image content from the image content source in the form of image content data, generate the rendered image data from the retrieved image content data and compare the rendered image data with existent rendered image data used to display an existent image page on the electronic paper display panel, and the second processor module is further configured to then execute a rendered image data transmission decision comprising transmitting the rendered image data to the first processor module when the rendered image data is different from the existent rendered image data used to display the existent image page on the electronic paper display panel, and not transmitting the rendered image data to the first processor module when the rendered image data is sufficiently similar to the existent rendered image data used to display the existent image page on the electronic paper display panel.

In at least one implementation, the second processor module can be configured to store image content data or rendered image data.

In at least one implementation, the first processor module can be configured to receive and store existent rendered image data corresponding with the existent image page currently displayed on the electronic paper display panel, and the second processor module is configured to receive and store previously rendered image data corresponding with image pages previously displayed on the electronic paper display panel.

In at least one implementation, the electronic paper display system can be configured to periodically power down for a power-down period subsequent to having transmitted the triggering signal and completed the execution of the image transmission decision, the power-down period ending with the transmission of the next triggering signal.

In at least one implementation, the image content can represent a monthly calendar, a weekly calendar, an agenda, or a clock.

In another aspect, the present disclosure provides, in at least one implementation, a process for displaying an image page on an electronic paper display panel containing a housing, wherein the process comprises:
receiving a command input at an input device to retrieve image content in the form of image content data from an image content source;
sending the command input from the input device to a second processor module located remotely to the housing;
retrieving, using the remotely located second processor module, the image content data from the image content source;
generating rendered image data, using the remotely located second processor module, from the retrieved image content data;
sending the rendered image data, using the remotely located second processor module, to a first processor module located in the housing;
sending the rendered image data, using the first processor module located in the housing, to a display driver module that is coupled to the electronic paper display panel; and
operating the display driver module to display the rendered image data on the image page on the electronic paper display panel.

In at least one implementation, the process can further comprise sending the retrieved image content in the form of image content data to the input device for display in the form of a displayed image on a display of the input device.

In at least one implementation, the process can further comprise modifying the received image content due to receiving additional user input at the input device, and sending modified image content data to the remotely located second processor module to generate modified rendered image data, sending the modified rendered image data content, using the remotely located second processor module, to the first processor module located in the housing; sending the modified rendered image data content, using the first processor module located in the housing, to the display driver module; and operating the display driver module to display an image page corresponding with the modified rendered image data on the electronic paper display panel.

In at least one implementation, the process can further comprise sending the received image content in the form of image data content via the remotely located second processor module to at least one second input device for displaying the image data content in the form of a displayed image on an input display of the at least one second input device.

In at least one implementation, the process can further comprise comparing the rendered image data with existent rendered image data used to display an existent image page on the electronic paper display panel, and operating the second processor module to then execute a rendered image data transmission decision comprising transmitting the rendered image data to the first processor module when the rendered image data is different from the existent rendered image data used to display the existent image page on the electronic paper display panel, and not transmitting the rendered image data to the first processor module when the rendered image data is sufficiently similar to the existent rendered image data used to display the existent image page on the electronic paper display panel.

In at least one implementation, the process can further comprise receiving user input at the input device for generating an authentication token to access the image content source or the second processor module, issuing the authentication token via the image content source or the second processor module to the input device, and taking action on at least one input command received at the second processor module or the image content source from the input device when the input commands are accompanied with the authentication token.

In at least one implementation, the at least one input command can be a command to modify the displayed image on the image page on the electronic display paper panel.

Other features and advantages of the present disclosure will become apparent from the following detailed description. It should be understood, however, that the detailed description, while indicating some implementations of the disclosure, are given by way of illustration only, since various changes and modifications within the spirit and scope of the disclosure will become apparent to those of skill in the art from the detailed description.

### BRIEF DESCRIPTION OF THE DRAWINGS

The disclosure is in the hereinafter provided paragraphs described, by way of example, in relation to the attached figures. The figures provided herein are provided for a better understanding of the example implementations and to show more clearly how the various implementations may be carried into effect. The figures are not intended to limit the present disclosure.

FIG. 1 is a schematic diagram of an electronic paper display system according to an example implementation of the present disclosure.

FIG. 2 is another schematic diagram of an electronic paper display system according to another example implementation of the present disclosure.

FIG. 3 is another schematic diagram of an electronic paper display system according to another example implementation of the present disclosure.

FIG. 4A is an illustration of an implementation of an example image displayed on an electronic paper display panel and multiple input device displays in a first state.

FIG. 4B is an illustration of an implementation of an example image displayed on an electronic paper display panel and multiple input device displays in a second state.

FIG. 4C is an illustration of an implementation of an example image displayed on an electronic paper display panel and multiple input device displays in a third state.

FIG. 4D is an illustration of an implementation of an example image displayed on an electronic paper display panel and multiple input device displays in a fourth state.

FIG. 5 is a schematic view of an example implementation of an electronic paper display device.

FIG. 6 is a flow chart showing an example implementation of a process for operating an electronic paper display system.

FIG. 7 is a flow chart showing another example implementation of a process for operating an electronic paper display system.

The figures together with the following detailed description make apparent to those skilled in the art how the disclosure may be implemented in practice.

### DETAILED DESCRIPTION

Various systems and processes will be described below to provide an example of an implementation of each claimed subject matter. No implementation described below limits any claimed subject matter and any claimed subject matter may cover methods, systems, devices, assemblies, processes or apparatuses that differ from those described below. The claimed subject matter is not limited to systems or processes having all of the features of any one system, method, device, apparatus, assembly or process described below or to features common to multiple or all of the systems, methods, devices, apparatuses, assemblies or processes described below. It is possible that a system or process described below is not an implementation of any claimed subject matter. Any subject matter disclosed in a system or process described below that is not claimed in this document may be the subject matter of another protective instrument, for example, a continuing patent application, and the applicants, inventors or owners do not intend to abandon, disclaim or dedicate to the public any such subject matter by its disclosure in this document.

As used herein and in the claims, singular forms, such as “a”, “an” and “the” include the plural reference and vice versa unless the context clearly indicates otherwise. Throughout this specification, unless otherwise indicated, the terms “comprise,” “comprises” and “comprising” are used inclusively rather than exclusively, so that a stated integer or group of integers may include one or more other non-stated integers or groups of integers.

The term “or” is inclusive unless modified, for example, by “either”. The term “and/or” as used herein means that the listed items are present, or used, individually or in combination. That is, “X and/or Y” is intended to mean X or Y or both, for example. As a further example, “X, Y, and/or Z” is intended to mean X or Y or Z or any combination thereof. In effect, this term means that “at least one of” or “one or more” of the listed items is used or present.

When ranges are used herein, such as for geometric parameters, for example lengths, all combinations and sub-combinations of ranges and specific implementations therein are intended to be included. Other than in the operating examples, or where otherwise indicated, all numbers expressing quantities of ingredients or reaction conditions used herein should be understood as modified in all instances by the term “about.” The term “about” when referring to a number or a numerical range means that the number or numerical range referred to is an approximation within experimental variability (or within statistical experimental error), and thus the number or numerical range may vary between 1% and 15% of the stated number or numerical range, as will be readily recognized by context. Furthermore any range of values described herein is intended to specifically include the limiting values of the range, and any intermediate value or sub-range within the given range, and all such intermediate values and sub-ranges are individually and specifically disclosed (e.g. a range of 1 to 5 includes 1, 1.5, 2, 2.75, 3, 3.90, 4, and 5). Similarly, other terms of degree such as “substantially” and “approximately” as used herein mean a reasonable amount of deviation of the modified term such that the end result is not significantly changed. These terms of degree should be construed as including a deviation of the modified term if this deviation would not negate the meaning of the term it modifies.

Unless otherwise defined, scientific and technical terms used in connection with the formulations described herein shall have the meanings that are commonly understood by those of ordinary skill in the art. The terminology used herein is for the purpose of describing particular implementations only, and is not intended to limit the scope of the present invention, which is defined solely by the claims.

All publications, patents and patent applications are herein incorporated by reference in their entirety to the same extent as if each individual publication, patent or patent application was specifically and individually indicated to be incorporated by reference in its entirety.

### Definitions

The term “system”, as used herein, refers to a device, or a configuration of a plurality of devices, with one or more electronic processors or other hardware capable of performing machine executable instructions, where the one or more devices include but, are not limited to, any personal computer, desktop computer, hand-held computer, mobile computer, laptop computer, tablet computer, cell phone computer, smart phone computer, or other suitable electronic device or plurality of devices.

At least a portion of the example implementations of the systems, devices, or methods described in accordance with the teachings herein may be implemented as a combination of hardware or software. For example, a portion of the implementations described herein may be implemented, at least in part, by using one or more computer programs (i.e. software or program instructions), executing on one or more programmable devices each comprising at least one processing element, and at least one data storage element (including volatile and non-volatile memory). These devices may also have, or be coupled to, at least one input device and at least one output device as defined herein.

It should also be noted that there may be some elements that are used to implement at least part of the implementations described herein that may be implemented via software that is written in a high-level procedural language such as object-oriented programming. The program code may be written in MATLAB™, Visual Basic, Fortran, C, C++ or any other suitable programming language and may comprise modules or classes, as is known to those skilled in object-oriented programming. Alternatively, or in addition thereto, some of these elements implemented via software may be written in assembly language, machine language, or firmware as needed.

At least some of the software programs used to implement at least one of the implementations described herein may be stored on a storage media (e.g., a computer readable medium such as, but not limited to, ROM, magnetic disk, optical disc) or a device that is readable by a general or special purpose programmable device. The software program code, when read by at least one processor or hardware logic of the programmable device, configures the at least one processor or hardware logic to operate in a new, specific and predefined manner in order to perform at least one of the methods described herein.

Furthermore, at least some of the programs associated with the systems, devices and methods of the implementations described herein may be capable of being distributed in a computer program product comprising a computer readable medium that bears computer usable instructions, such as program code or program instructions, for one or more processors. The program code may be preinstalled and embedded during manufacture and/or may be later installed as an update for an already deployed computing system. The medium may be provided in various forms, including non-transitory forms such as, but not limited to, one or more diskettes, compact disks, tapes, chips, USB keys, external hard drives, magnetic and electronic media storage, tablet (e.g. iPad) or smartphone (e.g. iPhones) apps, and the like, for example. In alternative implementations, the medium may be transitory in nature such as, but not limited to, wire-line transmissions, satellite transmissions, internet transmissions (e.g. downloads), media, as well as digital and analog signals, for example. The computer usable instructions may also be in various formats, including compiled and non-compiled code.

The term “cloud-based” in reference to certain computational tasks, as used herein, refers to a computational infrastructure comprising a combination of connections, hardware, software, data, information and services, accessed and shared, over a network. The computational infrastructure collectively can be referred to as “the cloud.”

The term “coupled”, as used herein, can have several different meanings depending on the context in which the term is used. For example, the term coupled can have a mechanical or electrical connotation depending on the context in which it is used, i.e. whether describing a physical layout or transmission of data as the case may be. For example, depending on the context, the term coupled may indicate that two elements or devices can be directly physically or electrically connected to one another or connected to one another through one or more intermediate elements or devices via a physical or electrical element such as, but not limited to, a wire, a non-active circuit element (e.g. resistor), or a wireless connection including, but not limited to cellular, Wi-Fi, low power wide area network (LPWAN), Bluetooth®, and the like, for example.

The terms “electronic paper” or “e-paper”, may be used interchangeably herein, and refer to display technologies capable of reflecting light, instead of emitting light, such as LCD or OLED display technologies. Electronic paper may be implemented using a plurality of cells, each including a fluid, and one or more particles responsive to an electrical stimulus, such as a voltage, for example. The particles typically have multiple stable states, including a first state where the particles are visible and a second state where the particles are not visible. Collectively the particles can be used to implement multi-stable electronic paper displays, which are display devices which can hold and move between two or more pixelated images in the absence of any substantial power supply, as a result of having cells for providing image pixels that are able to move between two or more states (e.g. black/white, or series of grey tones, or colors). It is noted that in some instances a light source may be included in an e-paper display to emit light to improve visibility in low light ambient conditions; however, the light source generates such light used to illuminate the display to improve visibility, and not as part of the display mechanism.

The term “input device”, as used herein, refers to any user operable device that is used to input information or user control data and includes but is not limited to, one or more of a terminal, a touch screen, a keyboard, a mouse, a mouse pad, a tracker ball, a joystick, a microphone, a voice recognition system, a light pen, a camera, a data entry device, such as a barcode reader or a magnetic ink character recognition device, a sensor or any other computing unit capable of receiving input data. Input devices may comprise a two dimensional display, such as a TV, an LCD, an OLED backlit display, or a mobile device display capable of receiving input from a user e.g. by touch screen. The user in accordance herewith may be any user or operator.

The term “module” as used herein, refers to a real world arrangement of components implemented using hardware, such as by an application specific integrated circuit (ASIC) or field-programmable gate array (FPGA), for example, or as a combination of hardware and software, such as by a processor system and a set of instructions to implement the module's functionality, which while being executed transform the processor system into a special-purpose device. A module can also be implemented as a combination of the two, with certain functions facilitated by hardware alone, and other functions facilitated by a combination of hardware and software. In certain instances, at least a portion, and in some cases, all, of a module can be executed on the processor(s) of one or more computers which execute an operating system, system programs, and application programs, while also implementing the module using multitasking, multithreading, or other such processing techniques. Accordingly, each module can be realized in a variety of suitable configurations, and should not be limited to any particular implementation illustrated or described herein.

### General Implementation of the System

As hereinbefore mentioned, in general the present disclosure relates to electronic paper display systems and processes for displaying images on electronic paper display systems. The systems and processes can be implemented in a manner that allows electronic paper display devices to operate substantially longer than conventional electronic paper display devices. This can generally be achieved without changing the dimensions of the electronic paper display device. Instead, the electronic paper display systems of the present disclosure can be configured to limit the dimensions of other components conventionally housed in electronic paper display devices, to thereby create more physical space in which a battery can be installed. In particular, the systems and processes of the present disclosure can be implemented in a manner that substantially reduces the size of the microcontroller unit (MCU) required to operate the electronic paper display device. Thus, for example, the inventors have determined that a battery having a charge of 6,000 milli-Ampere hours (mAh) can be installed in an example electronic paper display device of the present disclosure, instead of a 2,000 mAh battery without changing the overall physical dimensions of the device. When configured to be powered by a 6,000 mAh battery, an example electronic paper display device according to the present disclosure can be operated for about 10 days if the display is refreshed every minute; about 60 days if the display is refreshed every 5 minutes; about 115 days if the display is refreshed every 10 minutes; and about 210 days if the display is refreshed every 15 minutes. This represents approximately a 3× increase in time period during which no recharge is required in order for the electronic paper display system to continue to operate.

In what follows, selected implementations are described with reference to the drawings.

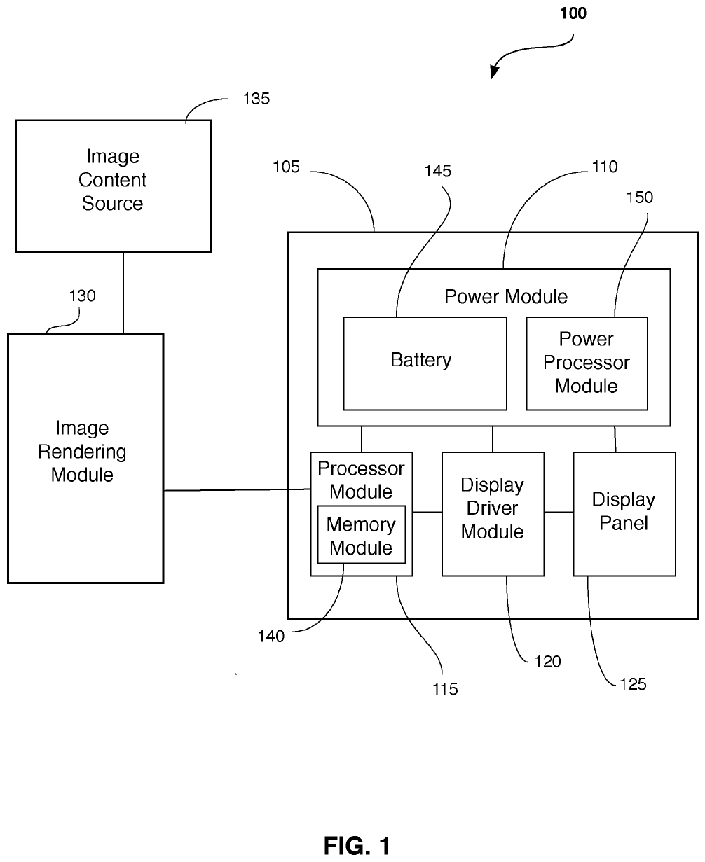

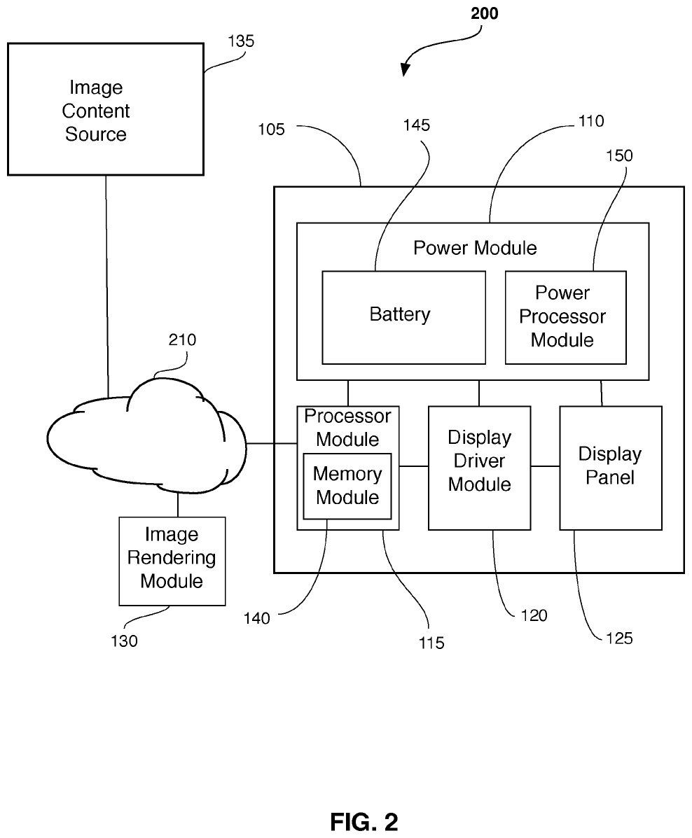

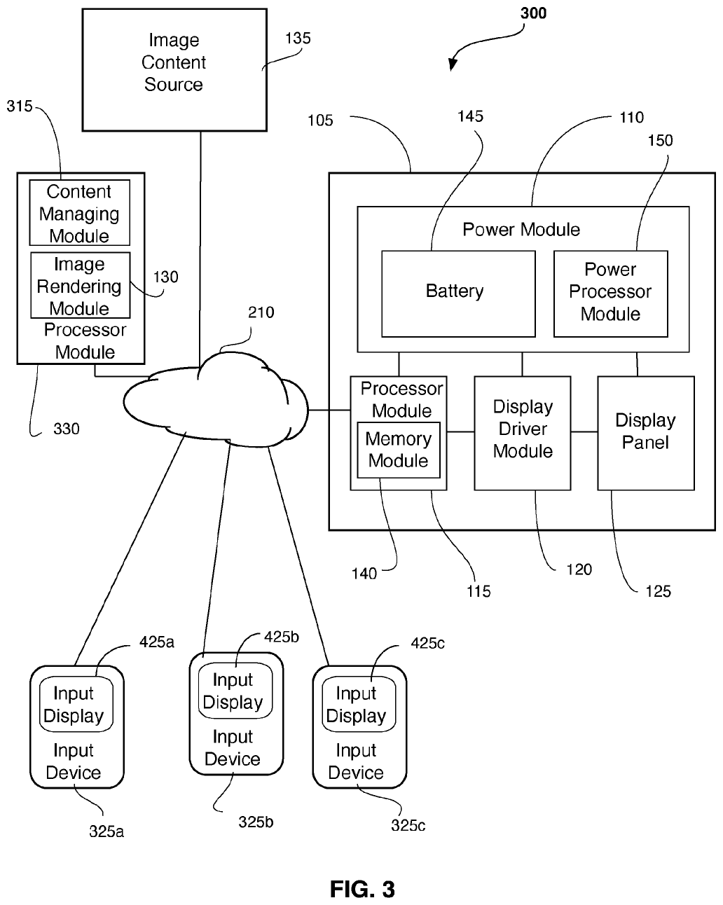

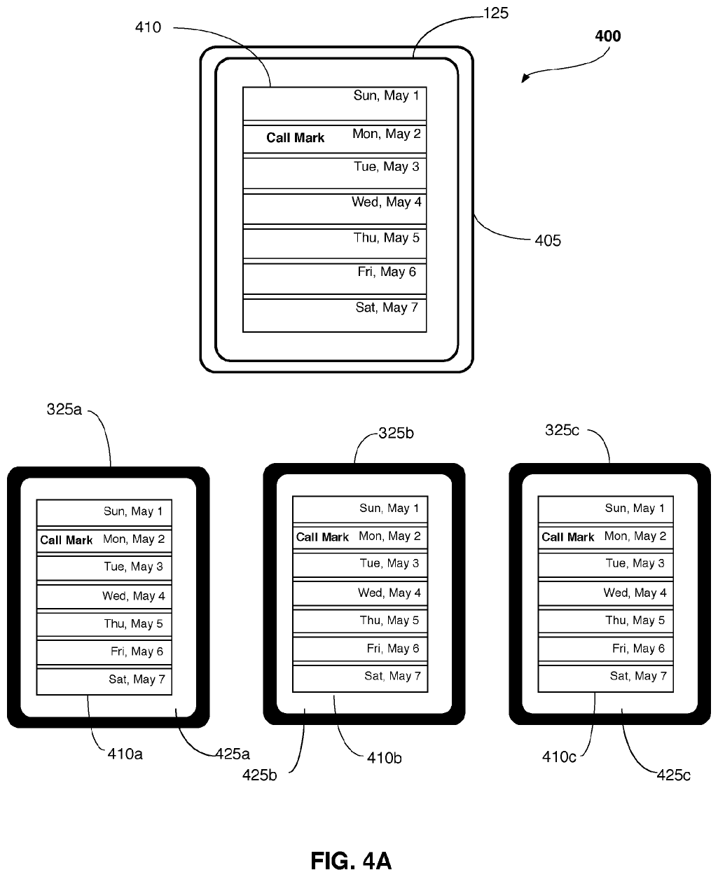

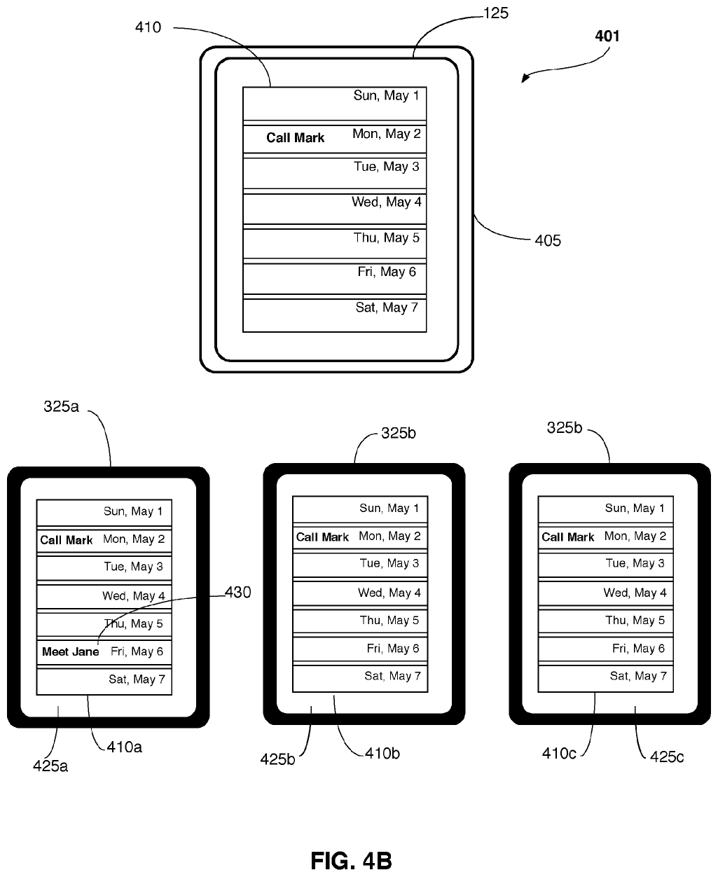

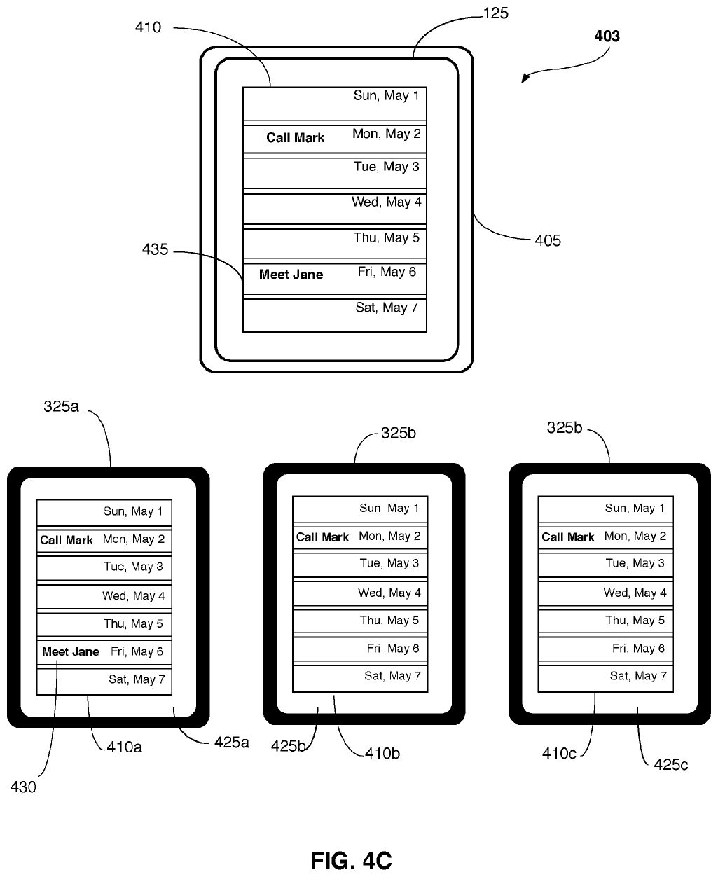

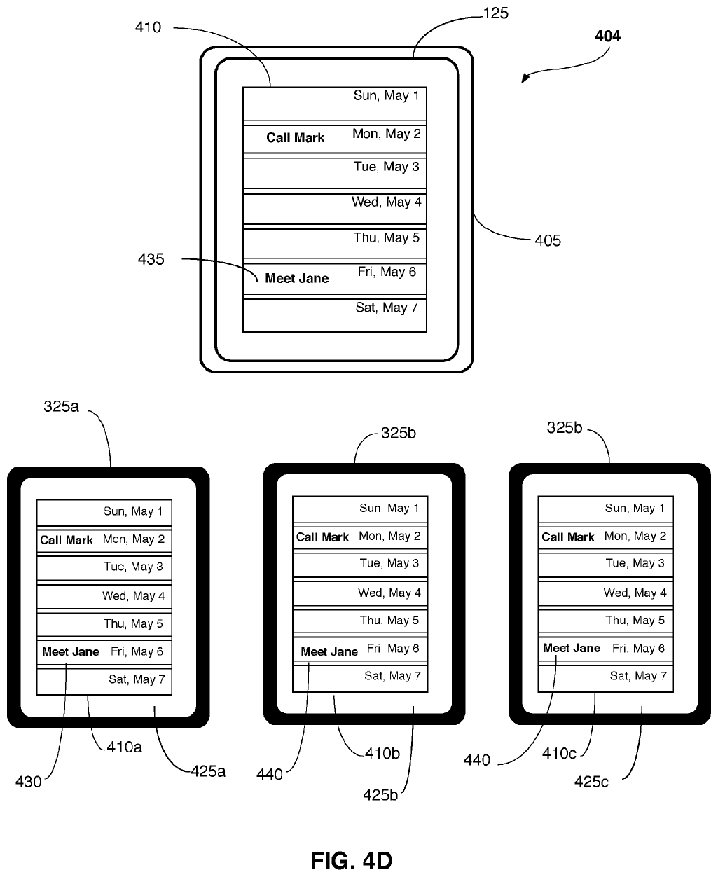

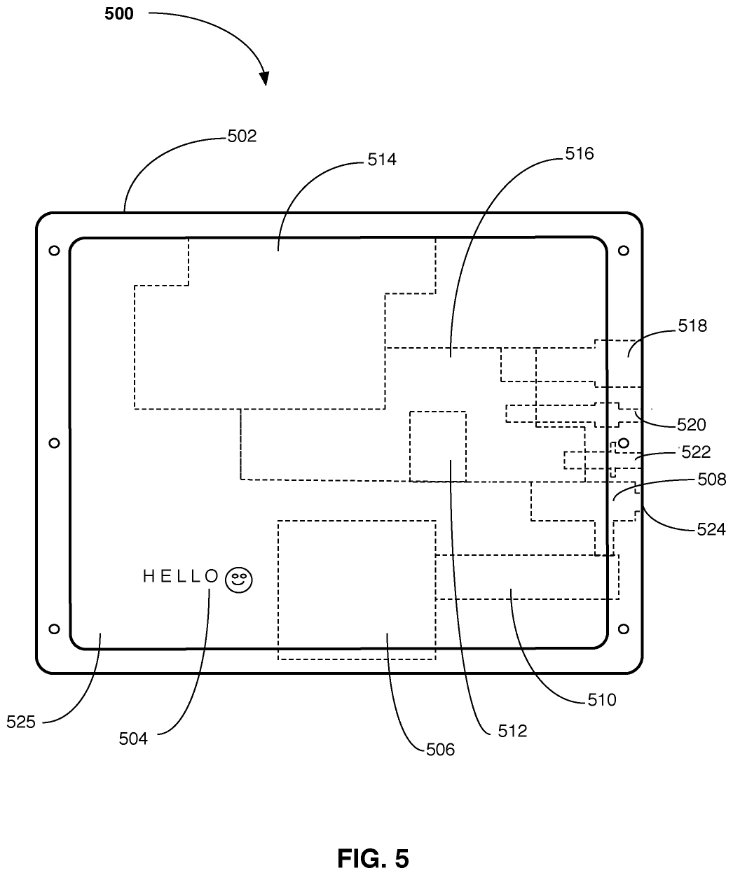

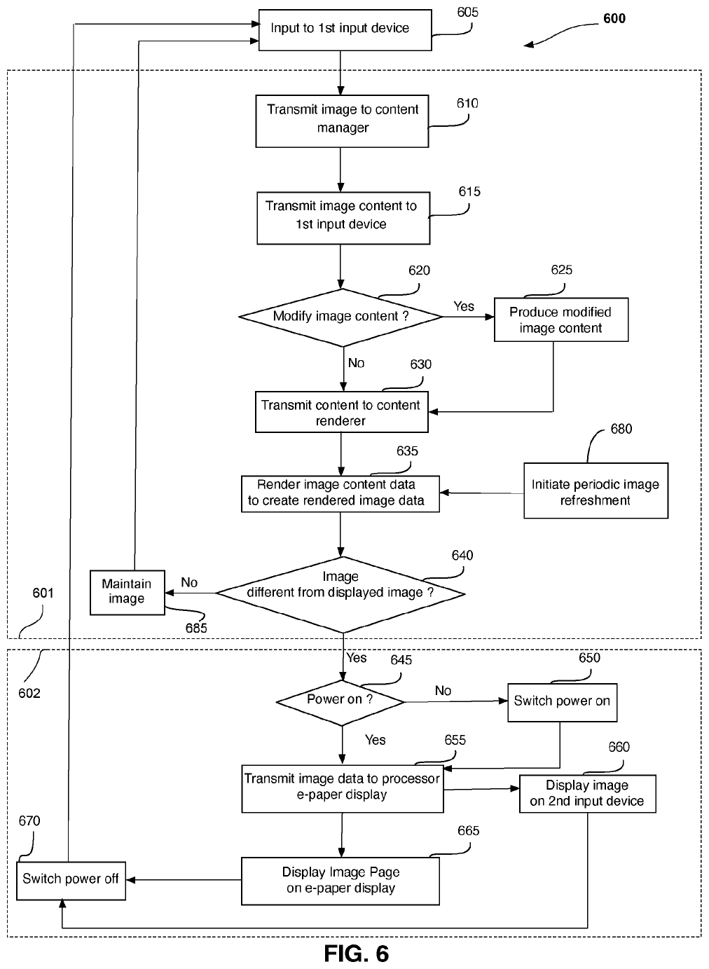

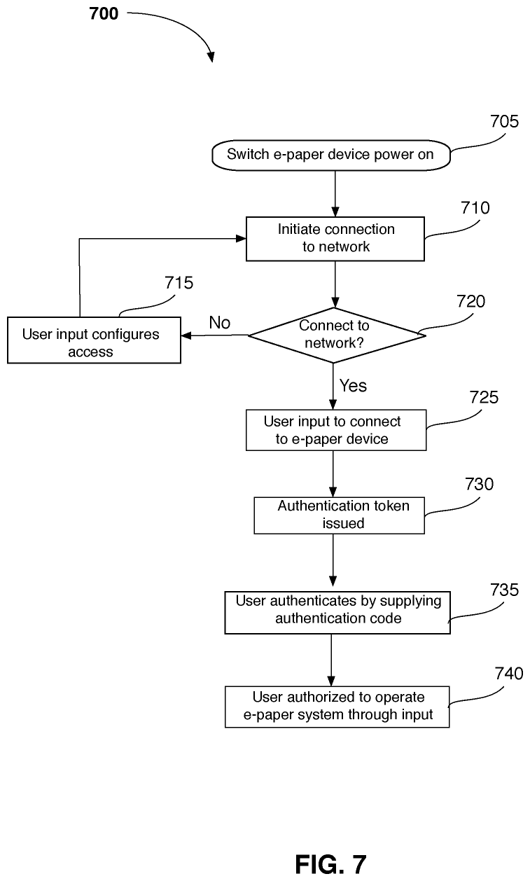

In general overview, FIG. 1, FIG. 2, and FIG. 3 show several schematic diagrams of example implementations of electronic paper display systems. FIGS. 4A-4D show example images displayed on an example electronic paper display device and input devices operated according to processes of the present disclosure in different states. FIG. 5 shows a top view of an example implementation of an electronic paper display device, including underlying hardware components. FIG. 6 and FIG. 7 show flow charts for example implementations of processes for operating electronic paper display systems.

Referring initially to FIG. 1, shown therein is a schematic diagram of an example of an electronic paper display system 100. Electronic paper display system 100 comprises electronic paper display device 105 housing electronic paper display panel 125. Electronic paper display panel 125 is coupled to display driver module 120 which drives (i.e. transmits) rendered image data to electronic paper display panel 125. Display driver module 120 in turn is coupled to processor module 115, which is configured to receive rendered image data and output the rendered image data to display driver module 120. Electronic paper display panel 125, display driver module 120 and processor module 115 are all coupled to power module 110, which provides power to electronic paper display panel 125, display driver module 120 and processor module 115. Power module 110 can also provide power to any additional electronically operated components (not shown) which require power to be operated and which may optionally be included within the electronic paper display device 105, such as, for example, a light source to illuminate electronic paper display device 105 and facilitate viewing in low ambient light conditions.

Electronic paper display panel 125 may be manufactured using any suitable e-paper technology, and may comprise, for example, one or more electrophoretic displays (EPDs), microelectromechanical systems (MEMS), electrochromic displays, bi-stable cholesteric displays and/or electro-wetting displays, permitting display of image pages thereon, in general in pixilated form, so that a user can view the displayed image.

The term “image”, as used herein, is meant to include any visually perceptible pixilated image, including, without limitation, any appearance, figure, form, picture, drawing, model, shape, illustration, likeness, and so forth, and further including, without limitation, any text, characters, words, letters, numbers, signs, logos, icons, pictograms, logograms, symbols, and the like. The related term “image page”, as used herein, refers to a surface area for display of an image.

In some example implementations, electronic paper display panel 125 is dimensioned to be generally planar and rectangular (as further shown in FIGS. 4A-4D). However, in other implementations electronic paper display panel 125 may be curved, for example to track the contours of a curved surface, such as a vehicle surface, or, for example, a surface compatible with a wearable device including electronic paper display panel 125. In example implementations, electronic paper display panel 125 may be formed on a plastic substrate, which may be thin, for example, about 1 mm or less, thus rendering electronic paper display panel 125 light weight, and less prone to cracking, when compared with, for example, displays formed on glass.

Processor module 115 is configured to receive rendered image data as well as provide rendered image data to the display driver module 120 for output thereon. The processor module 115 can include one or more processors which can be any suitable type of processor, such as a processor manufactured by Intel®, AMD®, ARM®, Microchip Technology, Espressif Systems, etc. including, for example, the ST8S105C6 microcontroller available from STMicroelectronics, Geneva, Switzerland, or a processor including a wireless radio such as ESP32 available from Expressif Systems, Shanghai.

Processor module 115 further includes or may be coupled to memory module 140, which is configured to store rendered image data corresponding with all or part of the image page that is to be displayed on electronic paper display panel 125 such as, for example, at least a row or column of rendered image data. In some implementations, memory module 140 may contain a memory buffer with sufficient storage to receive rendered image data corresponding to all pixels of an image for display on electronic paper display panel 125, so that processor module 115 can output data for all pixels to display driver module 120. Memory module 140, further may store operating parameters, such as, for example, the size and/or resolution of electronic paper display panel 125, voltage required to operate display driver module 120, the time interval for which data is accessed by processer module 115 for rendering on the electronic paper display panel 125, such as the number of update image page updates, and other operating parameters to facilitate operation of the electronic paper display device 105. Processor module 115 lacks modules for rendering image content and modifying image content, for reasons that will hereinafter be further explained.

Display driver module 120 is coupled to data processor module 115 and functions as an interface between data processor module 115 and electronic paper display panel 125. Display driver module 120 is configured to receive rendered image data, i.e. the output of processor module 115, and drive (i.e. transmit) the received rendered image data to electronic paper display panel 125 to thereby display an image page on electronic paper display panel 125 corresponding with the received rendered image data. Examples of suitable hardware components for the display driver module 120 include display driver modules manufactured by Pervasive Displays Inc., such as Pervasive EPD Extension Kit Gen 2 (EXT2).

Power module 110 provides power to electronic paper display panel 125, display driver module 120 and processor module 115, and includes battery 145 and power processor module 150. Battery 145 can be any battery suitable to power electronic paper display device 105, and in general is selected to be compatible with the physical dimensions of electronic paper display device 105 while providing the required power. One of the advantageous features of the systems for displaying images on an electronic paper display device of the present disclosure is that significantly more battery capacity can be installed and contained within electronic paper display device 105 compared to conventional systems, in particular, since electronic paper display device 105 does not include a rendering module or a content manager module, less processing power is required allowing for a simpler MCU, thus providing both power efficiency and more physical space to contain a battery. Thus, the time period during which the electronic paper display device 105 can operate without requiring a recharge is substantially longer than for conventional systems. Thus, for example, in an electronic paper display device comprising a rectangular screen size of approximately 19 cm by 24 cm and a housing size of approximately 22.2 by cm 26.8 cm by 1.2 cm, a battery providing 6,000 mAh can be installed. Such a battery can provide power to operate paper display device 105, at room temperature, for about 10 days, if the image page on electronic paper display panel 125 is refreshed every minute; about 60 days if the image page on electronic paper display panel 125 display is refreshed every 5 minutes; about 115 days if the image page on electronic paper display panel 125 is refreshed every 10 minutes; and about 210 days if the image page on electronic paper display panel 125 is refreshed every 15 minutes. As will be clear to those of skill in the art, larger batteries can be installed in devices having larger dimensioned electronic paper display panels; however, at the same time, larger dimensioned display panels will require more battery power to operate. Conversely smaller batteries can be installed in smaller dimensioned electronic paper display devices. A variety of different batteries 145 can be installed including, but not limited to, sheet batteries, button batteries, lithium-ion polymer batteries, and nickel-metal hydride batteries, for example. Battery 145 may be a non-rechargeable battery and replaced when drained, or may, preferably, be a rechargeable battery, so that it can be connected to an external power source e.g. an external alternating current (A/C) power supply or an external direct current (DC) power supply, mains electricity or wall power, or solar panel for recharging. Suitable batteries further include batteries manufactured by e.g. UnionFortune Electric Co. Ltd. such as, for example, UnionFortune model 585460.

Power processor module 150 is generally configured to control the flow of power from battery 145 to electronic paper display panel 125, processor module 115, and display driver module 120. In some implementations, power may be supplied by battery 145 to electronic paper display panel 125 intermittently. Thus, for example, since no power is required for display of a static image page on electronic paper display panel 125, power processor module 150 may be configured to only supply power to electronic paper display panel 125 when processor module 115 outputs new rendered image data to display driver module 120 to effect a change of the image page displayed on electronic paper display panel 125. Suitable hardware components for the power processor module include, for example, power processors manufactured by Microchip®, such as MCP73871.

It is noted that in some implementations of electronic paper display device 105, the device 105 can be powered by a power source not housed within electronic paper display device 105. Thus, for example, in some implementations electronic paper display device 105 may be powered by connecting the device 105 to mains electricity or wall power.

Referring next to FIG. 5, shown therein is a top view of an example implementation of the physical layout an electronic paper display device 500, including certain underlying hardware elements of various herein described modules. Electronic paper display device 500 comprises electronic paper display panel 525 housed in housing 502, for displaying image page 504. The paper display panel 525 is disposed along a front surface of the electronic paper display device 500 and the remaining components of the electronic paper display device 500 are disposed behind the display panel 525. Further shown are the following hardware elements: battery 506, power processor hardware 508, and external port 524 allowing coupling of battery 506 to an external power source (not shown), for battery recharging purposes. Battery 506 and power processor hardware 508 are coupled by power connection 510, (together forming a hardware element for power module 110). The hardware elements further include processor 512 (forming a hardware element for processor module 115); driver hardware 514 (forming a hardware element for display driver module 120); wiring conduit 516 and power switch 522 allowing a user of electronic paper display device 500 to turn electronic paper display device 500 off and on. The hardware elements further include communication port 518 for allowing coupling of an input device (not shown), e.g. a laptop or desk top computer, to electronic paper display device 500, and permit software programming of power module 110, processor module 115 and display driver module 120. The hardware elements further include switch 520 for allowing a user to toggle between a mode which permits software programming from an input device (not shown) and a mode which prohibits software programming from the input device, where the input device may be coupled to communication port 518. In other implementations, power module 110, processor module 115 and/or display driver module 120 may be accessed for software programming via a communication network.

Referring further again now to FIG. 1, electronic paper display system 100 further comprises remotely located image rendering module 130. Image rendering module 130 is configured to receive image content in the form of image content data and create rendered image data based on the received image content data to thereby generate rendered image data. The image content data is a digitized version of the image content that is electronically accessible. The term “remotely located” means that the image rendering module 130 is not located within the housing of the electronic paper display device 105. In order to receive image content data, image rendering module 130 is coupled to image content source 135. Image content source 135 may be any content source, such as a database, a data store, cloud storage, or some other memory element and includes image content including graphic images and text images, in the form of image content data, which may be provided from an accessible location, including from a location coupled to network 210 (see further: FIG. 2) (e.g. a cloud-based image content source), which may be operated by a content service provider, for example, or a news or other information service provider. Examples of image content, which is stored in the form of image content data which may be obtained from image content source 135 include, but are not limited to clock image content (e.g. a series of clock images for updating to the time to correspond with the current time), calendar image content, signage image content (e.g. for display on billboards), wearable device image content (e.g. fitness parameters, which may, for example, be a series of fitness parameter images which may be updated, e.g. as a function of fitness sensor data), and so forth. Image content may be provided by service providers, for example, calendar or clock image content may, for example, be provided by Google® Calendar, Microsoft® Exchange or Apple® i-cloud. It should be noted that the present disclosure is not limited with respect to the actual image content, and it is clearly understood that any and all image content, that can be displayed on an image page of an electronic paper device is intended to be included within the scope of the present disclosure.

The rendering process performed by image rendering module 130 may be any suitable process that can convert image content data received from image content source 135, into a rendered image data compatible with electronic paper display panel 125, e.g. a rendering process compatible with MEMS technology, EPD technology etc. Thus, for example, image content data received from image content source 135 can be rendered by image rendering module 130 so that upon the performance of a rendering process, rendered image data is generated in the form of a pixilated 2D grid comprising rows and columns. Suitable image rendering processes to include in image rendering module can be provided by further including, for example, open source software such as Node.js HTML5 Canvas image renderer. Upon completion of the rendering, image rendering module 130 can transmit rendered image data to processor module 115 contained in electronic paper display device 105.

Referring next to FIG. 2, shown therein is a schematic diagram of another example electronic paper display system 200 according to the present disclosure. Electronic paper display system 200 includes an image rendering module 130 in a remote location and is coupled to processor module 115 via network 210, e.g. a wireless network such as a cellular network. Thus remotely located image rendering module 130 can, in some implementations, be cloud-based, i.e. a provider makes module 130 available over a network. As noted above, image content source 135 can also be connected to network 210, and can be cloud-based. Otherwise, the electronic paper display system 200 is implemented in a similar fashion as the electronic paper display system 100.

Referring next to FIG. 3, shown therein is a schematic diagram of another example implementation of an electronic paper display system 300 according to the present disclosure. Electronic paper display system 300 is configured to be able to communicate with input devices 325a, 325b and 325c through communication network 210, and can receive inputs or commands from at least one of the devices 325a, 325b and 325c and image content data to the devices 325a, 325b and 325c. Electronic paper display system 300 further includes remotely located second processor module 330 comprising content managing module 315 and image rendering module 130, coupled to network 210. Input devices 325a, 325b and 325c contain input displays (e.g. an LCD screen) 425a, 425b and 425c. It is further noted that while only 3 input devices are shown, in some implementations, more input devices can communicate with electronic display system 300. Content managing module 315 is configured to store image content data and rendered image data and thus includes a memory module and processor (both not shown) to retrieve and transmit image content data. It is noted that memory module 140 is also configured to store rendered image data. In different implementations, rendered image data may be stored implemented using memory module 140, content managing module 315, or both modules 140, 315. Thus, for example, in at least one implementation, memory module 140 may be configured to only store the existent rendered image data corresponding with the existent image page currently displayed on electronic paper display panel 125, while content managing module 315 may be configured to store additional rendered image data, for example, rendered image data corresponding with previously displayed image pages, or rendered image data corresponding with image pages for transmission to processor module 115 for later display on the display panel 125. Memory module 140 further may be configured to store rendered image data relating to certain operational aspects of electronic paper display system 300, such as “low battery”, or “no network connection”, which may be displayed on electronic paper display panel 125 to provide a status update for the operation of electronic paper display system 300.

Continuing to refer to FIG. 3, in at least one implementation, input devices 325a, 325b and 325c are configured to receive input from one or more users of input devices 325a, 325b or 325c. The user input is for selecting image content. Furthermore, input devices 325a, 325b and 325c are configured to provide the user input to remotely located second processor module 330, in particular to content managing module 315, to retrieve selected image content data. Content managing module 315 is coupled to image content source 135 via network 210 to send a retrieval request to the image content source 135 to retrieve the selected image content data from image content source 135. Upon receipt of the selected image content data, content managing module 315 stores the received selected image content data, and transmits the received selected image content data for display in the form of a displayed image on the input displays 425a, 425b and 425c of at least one of input devices 325a, 325b and 325c, respectively. It is noted that inasmuch as input devices 325a, 325b and 325c themselves are not e-paper devices, such retrieval and display of the selected image content on input displays 425a, 425b and 425c does not require any operational actions of image rendering module 130. Thus, in this implementation, one or more users of input devices 325a, 325b and 325c can select image content and then view the corresponding selected image content on input displays 425a, 425b and 425c, respectively, and the selected image content is also displayable on electronic paper display panel 125. At the same time, in this implementation, a record of received selected image content is retained.

Processor module 115, in at least one implementation, is configured to compare rendered image data generated as a result of user input received from input devices 325a, 325b or 325c with the existent rendered image data corresponding with an existent image page currently displayed on electronic paper display panel 125, and previously stored by content managing module 315 and/or memory module 140. In at least one implementation, in the event part or all of the rendered image data is sufficiently similar to the existent rendered image data corresponding with the existent image page currently displayed on electronic paper display panel 125, only the parts of the rendered image data that are different may be provided as output to display driver module 120, thus resulting in no update, or a partial update of the image page displayed on electronic paper display device 125. By the term “sufficiently similar” it is meant that at least about 90%, 95%, 96%, 97%, 98%, 99% or 100% of the pixels constituting the image data are identical. Thus, in this implementation, the one or more users of input devices 325a, 325b and 325c can provide user inputs to the input devices 325a, 325b and 325c to receive and view selected image content on input displays 425a, 425b and 425c, and can provide additional user input on input displays 425a, 425b and 425c to display the selected image content on electronic paper display panel 125.

In at least one implementation, input devices 325a, 325b and 325c are configured to receive user input from one or more users of input devices 325a, 325b or 325c to select image content, and provide the user input to content managing module 315 to retrieve the corresponding selected image content data, and after receiving the selected image content data to display the corresponding received image content on the input displays 425a, 425b and 425c of input devices 325a, 325b or 325c, respectively. Furthermore, input devices 325a, 325b and 325c are configured to modify the received image content data by receiving additional user input from input devices 325a, 325b or 325c and provide the additional user input to content managing module 315 to generate and transmit modified image content data to image rendering module 130. Image rendering module 130 renders the modified image content data and transmits the rendered modified image data corresponding with the modified image content data to first processor module 115, which subsequently effects display of an image page corresponding to the modified image content on electronic paper display panel 125. Thus, in this implementation, one or more users using one of the input devices 325a, 325b or 325c can send a request to retrieve selected image content, then receive the selected image content, view the received selected image content on the corresponding input display 425a, 425b or 425c, provide additional input to modify the received selected image content, and provide further input using input devices 325a, 325b or 325c to display the modified selected image content on electronic paper display panel 125.

In another implementation, processor modules 115 and 130 are configured to transmit modifications to the existent image page currently displayed on display panel 125 to content managing module 315 and in turn to input devices 325a, 325b and 325c. In particular, after having received input commands, and after having used the user input commands for modification of image content, input devices 325a, 325b or 325c can further be used to provide additional input to display selected modified image content for viewing thereof on input displays 425a, 425b or 425c of input devices 325a, 325b, or 325c, respectively, as hereinbefore described with respect to image content. Thus, if a user of input devices 325a, 325b or 325c initiates the modification of the image content on electronic paper display panel 125, the other users of 325a, 325b or 325c can be notified of modifications of image pages on display panel 125.

The foregoing is further illustrated, by way of example, in FIGS. 4A-4D. Referring now to FIGS. 4A-4D, shown therein is an example implementation 400 of four states of an image page showing calendar 410 displayed on electronic paper display panel 125 of electronic paper display device 405. Calendars 410a, 410b and 410c are also displayable on input displays 425a, 425b and 425c of input devices 325a, 325b and 325c, respectively. In a first state (FIG. 4A), calendars 410, 410a, 410b, and 410c are shown to be identical. In a second state, (FIG. 4B) a user of input device 325a has modified the image content by adding a calendar entry 430 (“Meet Jane”), as can be seen on input display 425a. The user further has provided input to input device 325a to modify the image page showing calendar 410 displayed on electronic paper display panel 125 of an electronic paper display device 405, resulting in the display of modified image page 435 on electronic paper display panel 125 and third state (FIG. 4C). In a fourth state (FIG. 4D), processor module 115 (not shown), has further transmitted the rendered image data corresponding with image displayed on the modified image page 435 on electronic paper display panel 125 to content managing module 315, which in turn has transmitted modified image page 440 to input devices 325b and 325c for display on input displays 425b and 425c for viewing by the users of devices 325b and 325c. In another implementation, content managing module 315 is configured to transmit modified image page 440 to input devices 325b and 325c for viewing on input displays 425b and 425c without requiring input from processor module 115. Thus, modified image page 440 is transmitted by content managing module 315 to input devices 325b and 325c, upon the user having provided input to input device 325a without requiring input from processor module 115.

In at least one implementation, processor module 130 is configured to compare the new rendered image data, e.g. image data rendered as a result of user input from input device 325a, 325b, or 325c, as shown by way of example in FIGS. 4A-4D, with existent rendered image data used to display an existent image page on electronic paper display panel 125, and transmit the new rendered image data to first processor module 115 when the new rendered image data is different from the existent rendered image data used to display the existent image page on electronic paper display panel 125. Thus, for example, if a user of an input device, for example a user of input device 325a, alters a calendar, by adding a calendar entry, e.g. “Meet Jane”, second processor module 130 is configured to compare the new rendered image data, i.e. rendered image data including “Meet Jane”, with existent rendered image data used to display an existent image page on electronic paper display panel 125 (i.e. an image page not showing “Meet Jane”), and transmit the new rendered image data to first processor module 115 since the new rendered image data is different from the existent rendered image data used to display the existent image page on electronic paper display panel 125. The first processor module 115 then operates in conjunction with the display driver module 120 to update the image page on the display panel 125 with the new rendered image data, as explained previously.

In at least one alternative implementation, the second processor module 330 is configured to: (a) receive user image content in the form of user image content data from at least one user of one of the input devices 325a, 325b or 325c, (b) render the user image content data to form rendered user image content data, and (c) send the rendered user image data to the first processor module 115 which then drives the display driver module 210 to replace the existent image page on the display panel 125 with an image page corresponding with the rendered user image content.

In at least one implementation, processor module 115 is configured to periodically transmit a triggering signal instructing processor module 130 to retrieve (i.e. acquire or obtain) image content in the form of image content data from the image content source 135, create rendered image data from the retrieved image content data and transmit the rendered image data to processor module 115 to thereby effect display of an image page corresponding with the rendered image data on electronic paper display panel 125. The periodicity with which the triggering signal is transmitted may vary. Thus, for example, when the displayed image page represents a clock, in some implementations, the periodicity may be once per minute, or when the image page represents a calendar month, the periodicity may be once per month.

In at least one implementation, processor module 115 is configured to periodically transmit a triggering signal instructing processor module 330 to retrieve image content from image content source 135, create rendered image data from the retrieved image content and compare the rendered image data with existent rendered image data used to display a current (i.e. existent) image page on electronic paper display panel 125. Processor module 330 is further configured to then execute a rendered image data transmission decision comprising transmitting the rendered image data to processor module 115 when the rendered image data is different from the existent rendered image data used to display the existent image page on electronic paper display panel 125, and not transmitting the rendered image data to processor module 115 when the rendered image data is sufficiently similar to the existent rendered image data used to display the existent image page on electronic paper display panel 125.

In at least one implementation, power processor module 150 of electronic paper display system 300 is configured to periodically power down for a power-down period, for example, subsequent to having transmitted a triggering signal and completed the execution of the rendered image data transmission decision, the power-down period ending with the transmission of the next triggering signal.

It is noted that in example implementation 300, three input devices 325a, 325b and 325c are shown. Furthermore, a single electronic paper display panel 125 is shown. In other implementations, the electronic display system 300 can be configured to receive input from/and send image content data to more input devices or fewer input devices and/or more electronic paper display panels. Thus, for example, in certain implementations hereof wherein the electronic paper display panels are used as billboards, a plurality of electronic paper display panels (e.g. 10, 100, 1,000 or more) can be included in the system, and the image page displayed on the plurality of the billboards comprising electronic paper display panels can be modified more or less simultaneously using a single input device.

To briefly recap, described above are certain example implementations of an electronic paper display system. The system includes a battery powered electronic paper display device containing a first processor module, and, remotely located to the electronic paper display device, a second processor module. The second processor module is configured to retrieve image content data from an image source, and to render image data from the retrieved image content data. The second processor module is further configured to transmit the rendered image data to the first processor module which then sends the rendered image data to a display driver to display an image page corresponding with the rendered image data on a display of the electronic paper device. Furthermore, the system can be configured to communicate with one or more input devices to control the display of image content on the electronic paper display system

It will now be apparent that the electronic paper display system of the present disclosure can be configured to perform a plurality of processes. Next, certain example processes are illustrated with reference to FIG. 6, FIG. 7, in conjunction with FIG. 3.

Referring to FIG. 6 in conjunction with FIG. 3, shown therein is a flow chart showing an example implementation of process 600 for operating an electronic paper display system according to the present disclosure. Referring to FIG. 3, it is noted that the process steps delineated by box 601 can be executed by electronic display device 105. The process steps delineated by box 602 can be executed by processor module 330 and image content source 135.

Referring to FIG. 6 again, example process 600 starts with loading of an interface, such as a graphical user interface, on an input display of an input device, for example, input device 325a, where the interface is capable of receiving commands from a user that interacts with input device 325a. After process 600 has started, it waits for the performance of step 605 by a user of input device 325a, which comprises receiving, from a user, an input command for selecting image content and receiving the image content in the form of image content data on input device 325a. Process 600 then proceeds with step 610, comprising sending the input command to the image content source 135 through network 210 and receiving the retrieved image content in the form of image content data at the image content managing module 315, and subsequently with step 615 comprising transmitting the retrieved image content data through network 210 to input device 325a for viewing by the user by displaying the retrieved image content data in the form of a displayed image on an input display of input device 325a. Process 600 then waits to receive an additional command from the user at step 620 which comprises either modifying or not modifying the retrieved image content data. Upon receiving an image content modification command from the user through input device 325a for modification of the retrieved image content data, the user command is sent to the content managing module 315 (step 625) through network 210 and the content managing module 315 which modifies the retrieved image content data to generate modified image content data according to the image content modification command, and the modified image content data is transmitted to image rendering module 130 (step 630). In the event a user opts to not modify the retrieved image content data, user input is provided to input device 325a to perform step 630 based on the initially retrieved image content data received in the performance of step 615. It is noted that in at least one implementation, process 600 proceeds to step 620 without awaiting the receipt of input from a user. Instead in the absence of the user input to modify the retrieved image content data, process 600 automatically proceeds from step 620 to step 630. Process 600 then proceeds with step 635 comprising image rendering module 130 rendering the retrieved image content data, or modified retrieved image content data, as the case may be, to thereby create rendered image data.

Continuing to further refer to FIG. 6, in conjunction with FIG. 3, next, using content managing module 315, process 600 determines when the rendered image data differs from the existent rendered image data used to display the current image page on electronic paper display panel 125 (step 640). Only when the existent rendered image data is sufficiently different does process 600 proceed to step 655 after act 645. Therefore, it is noted that the process 600 does not transition from the process steps delineated by box 601 to the process steps delineated by box 602, and no engagement of electronic display device 105 takes place when the existent rendered image data is not sufficiently different than the just rendered image data. Accordingly, when the recently rendered image data is substantially identical compared to the existent rendered image data, process 600 proceeds, in at least one implementation, to step 685, and the current image page displayed on display panel 125 is maintained. If, on the other hand, the recently rendered image data is substantially different compared to the existent rendered image data then this results in a transition from the process steps delineated by box 601 to the process steps delineated by box 602, and engagement of electronic display device 105 takes place.

Step 680 which may employ a timer that initiates the image refresh when the process 600 has not received any user inputs (step 605) to modify the image content but a change is needed on the image page which is ultimately displayed on the display panel. Thus, for example, step 680 which may be controlled by a timer mechanism, and may be executed periodically when there are periodic updates that are needed to the image page, such as, for example, once every 24 hours when the current day in a calendar shown in the image page has to be updated. In this fashion a fresh image can be regularly generated, even if there has been no or limited activity at step 605, as hereinafter further described. Thus, for example, a calendar image may be refreshed once every day even if no inputs are received at step 605.

It is noted that in some implementations, step 640, together with step 685 is omitted. This results in the execution of the step 645 following step 635, and thus the image page displayed on display panel 125 is automatically refreshed, whether the rendered image data is sufficiently different or not compared to the rendered image data that is used to generate and display the existent image page on the display panel. However, implementations in which step 640 is included are deemed particularly beneficial when step 640 is performed in combination with steps 645 and 650. Notably in the event, when newly rendered image content data is determined to be sufficiently similar to rendered image content data for the existent image page at step 640, step 685 can be performed instead of step 645. Thus, the use of power from battery 145 may be avoided in the event that the newly rendered image data is sufficiently similar to the existent rendered image data used to display the current image page on electronic paper display panel 125 and so there is no need to update the image page that is currently displayed on the electronic paper display panel 125. It is noted that this feature is in particular beneficial, since electronic paper display systems unlike more traditional display technologies, such as liquid crystal diode (LCD) or organic light emitting diode (OLED), do not require any power to display an image, and in the absence of power, a displayed image may be displayed substantially indefinitely.

Continuing further to refer to FIG. 6, in conjunction with FIG. 3, power processor module 150 is configured to determine when power supplied by battery 145 to operate electronic paper display 125 and display driver module 120 is switched on, and, if necessary, to switch power supplied by battery 145 on (steps 645, 650) (“device wake-up”). Next, process 600 comprises transmitting rendered image data from image rendering module 130 to processor module 115, located within electronic paper display device 105 (step 655). It is noted that in at least one implementation, image content managing module 315 and image rendering module 130 may be configured so that only a portion of the rendered image data is transmitted to processor module 115. In particular, content managing module 315 and image rendering module 130 may be configured so that only the portion of rendered image data which differs from the existent rendered image data used to display the current image page on electronic paper display panel 125 is transmitted to processor module 115. In this manner, for example, in implementations where the image content is a calendar, only the portions of the image page representing the portion of the calendar that is updated may be transmitted and then displayed on the electronic paper display panel. The foregoing is deemed beneficial as it may take less power from battery 145 to only revise a portion of the image page displayed on electronic paper display panel 125.

Thereafter process 600 proceeds by processor module 115 providing rendered image data as output to display driver module 120, and, next with display driver module 120 driving electronic paper display device 125, to display an image page on electronic paper display device 125 in accordance with (i.e. to show) the rendered image data (step 665). Subsequently process 600 proceeds with step 670 (“device sleep”), and power processor module 150 switches power supplied by battery 145 off (i.e. “device sleep”) until required again following iteration of process 600. It is noted that in at least one implementation, steps 645, 650 and 670 (i.e. device sleep and wake-up) may be omitted and battery 145 may continuously be providing operating power for the system, however steps 645, 650 and 670 are preferred in implementations where it is desirable to limit the use of power to operate electronic paper display device 105.

Continuing further to refer to FIG. 6, in conjunction with FIG. 3, it is noted that process 600 further includes step 660. Step 660 is performed more or less contemporaneously with the performance of steps 645, 650, 655 and 665, and comprises transmitting and displaying an image page corresponding with the image page displayed on electronic paper display panel 125 on the input display of one or more other input devices 325b, 325c that are coupled with the electronic paper display system. Step 660 may be executed by image content managing module 315, processor module 115, or a combination thereof. It is noted that step 660 is optional and not executed in the event the electronic paper display system only communicates with a single input device.

Continuing further to refer to FIG. 6, in conjunction with FIG. 3, it is noted that process 600 further includes step 680. Step 680 is performed automatically and comprises periodically refreshing the displayed image. Step 680 may be implemented using a stored version of the image content data displayed on display panel 125. Such a stored version may be stored on memory module 140 or content managing module 315. Alternatively, step 680 may be implemented by obtaining an image page from image source 135, rendering image data from the obtained image page (step 635), transmitting the corresponding rendered image data to processor module 330, determining when the rendered image data is substantially different than the existent rendered image data (step 640) and when so then proceed with step 655. Step 680 can be performed by processor module 115 in conjunction with processor module 330, and can proceed independently from any possible user input received from an input device according to step 605 and may, for example, be performed using a timer as explained previously. It is noted that step 680 is optional. Step 680 can be beneficially included, for example, when an image page displayed on electronic paper display device 125 comprises information which may need periodic automatic updating, for example, when an image page includes a calendar (monthly), or a clock displaying time by minute intervals minutes (every minute).

Referring now to FIG. 7 in conjunction with FIG. 3, shown therein is a flow chart showing an example implementation of process 700 for operating an electronic paper display system according to another aspect of the present disclosure. Process 700 starts with step 705 comprising, switching electronic paper display device 105 on, or after waking up after an predefined period of programmed inactivity, such as a programmed device sleep. Electronic paper display device 105 then attempts to connect to network 210, for example, by establishing a Wi-Fi or cellular network connection (step 710). Alternatively, or in the absence of an available network connection (step 720), a user using an input device (e.g. a laptop computer or a mobile telephone) configured to establish network connections, can establish a connection between electronic paper display system 100 and network 210 (step 715), for example, by using device input commands using the input device. Process 700 then proceeds with waiting for user input from an input device, for example, input device 325a, to request access to the electronic paper display system through input device 325a, including, for example, a user name and/or password. Upon having received such user input (step 725), process 700 then proceeds with issuing an authentication token from image content source 135 and/or from second processor module 330 to input device 325a (step 730). As the user subsequently seeks access to image content source 135 and/or second processor module 330, he is authenticated by supplying the issued authentication token (step 735), and can then interact with the electronic paper display system 100. Thus the process 700 includes taking action on at least one input command from the input device that is received at the second processor module or the image content source when the input commands are accompanied with the authentication token. As will be known to those of skill in the art, authentication tokens may be time limited, and/or limited with respect to the contents and/or functionality that may be accessed using the authentication token, e.g. view only access, or view and modify access, or calendar access, or clock access, or calendar and/or clock access. Thereafter various processes, such as process 600, can be initiated. Subsequently a user has access to the electronic paper display system 100 through input device 325a and can perform various processes, such as process 600 (step 635), for example.

As can now be appreciated, the electronic paper display systems of the present disclosure can be used to display image pages on electronic paper display devices. The contents of the image pages can be modified using one or more separate input devices which can access the electronic paper display systems in accordance with at least one implementation of the present disclosure. The electronic paper display systems of the present disclosure are particularly suitable in implementations of electronic paper display systems where it is desirable to extend the time period during which no battery recharges are required in order to operate the electronic paper display devices.

While the applicant's teachings described herein are in conjunction with various implementations for illustrative purposes, it is not intended that the applicant's teachings be limited to such implementations. On the contrary, the applicant's teachings described and illustrated herein encompass various alternatives, modifications, and equivalents, without departing from the implementations described herein, the general scope of which is defined in the appended claims.

1. An electronic paper display system comprising:
an electronic paper display device comprising a housing containing:
an electronic paper display panel configured to display an image page;
a display driver module coupled to the electronic paper display panel to drive the electronic paper display panel to display rendered image data on the image page; and
a first processor module coupled to the display driver, the first processor module being configured to receive the rendered image data and to output the rendered image data to the display driver module; and
a remotely located second processor module separate from the electronic paper display device and coupled to the first processor module, the second processor module being configured to receive image content in the form of image content data transmitted thereto by an image content source, to generate the rendered image data based on the received image content data and to transmit the rendered image data to the first processor module.

2. The electronic paper display system according to claim 1, wherein the second processor module is cloud-based.

3. The electronic paper display system according to claim 1, wherein the housing further contains a battery that is configured to provide power for the electronic paper display device.

4. The electronic paper display system according to claim 1, wherein the second processor module alone, or the second processor module and the first processor module together are configured to compare the rendered image data with existent rendered image data used to display an existent image page on the electronic paper display panel, and transmit the rendered image data to the first processor module when the rendered image data is different from the existent rendered image data used to display the existent image page.

5. The electronic paper display system according to claim 1, wherein the electronic paper display system further is configured to communicate with one or more input devices that each comprise an input display and are configured to receive a first input from one or more users for selecting image content from the image content source, and the second processor module is configured to: (a) retrieve the selected image content in the form of image content data from the image content source and send the retrieved selected image content data to the one or more input devices for display thereon in the form of displayed image content; and (b) modify the selected image content data when an image content modification input is received from the one or more input devices and transmit the modified selected image content data for display in the form of displayed modified image content on the input display of the one or more input devices.

6. The electronic paper display system according to claim 4, wherein the second processor module is configured to: (a) receive user image content in the form of user image content data from at least one user of one or more input devices, (b) render the user image content data to form rendered user image content data, and (c) send the rendered user image data to the first processor module which then drives the display driver module to replace the existent image page on the display panel to replace the existent image page on the electronic paper display panel with an image page corresponding with the rendered user image content.

7. The electronic paper display system according to claim 1, wherein the second processor module is configured to display image content on an input display of one or more input devices that are communicatively coupled to the system where the image content corresponds with an existent image page displayed on the display of the electronic paper display panel, and the second processor module is further configured to (a) receive user input for modifying image content data corresponding with image content on the one or more input devices, (b) modify the image content data, (c) render image data corresponding with the modified image content data, and (d) transmit the rendered image data to the first processor module, and wherein the first processor module is configured to replace the existent image page on the electronic paper display panel with an image page corresponding with the modified image content.

8. The electronic paper display system according to claim 1, wherein the second processor module is configured to display the image content on the input display of at least first and second input devices corresponding with an existent image page displayed on the electronic paper display panel, and the second processor module is further configured to: (a) receive user input for modifying image content data corresponding with the displayed image content on one or more of the input devices, (b) modify the displayed image content data, (c) render the modified displayed image content data and (d) transmit the rendered modified image content data to the first processor module, and the first processor module is configured to send the rendered modified image content data to the display driver module for driving the electronic paper display panel to display a modified image page corresponding with the modified image content, and the first and second processor modules are further configured to transmit the modified image content data to the at least one first and second input devices to for display of the modified image content thereat.

9. The electronic paper display system according to claim 1, wherein the first processor module is configured to periodically transmit a triggering signal instructing the second processor module to retrieve the image content from the image content source in the form of image content data, generate the rendered image data from the retrieved image content data and compare the rendered image data with existent rendered image data used to display an existent image page on the electronic paper display panel, and the second processor module is further configured to then execute a rendered image data transmission decision comprising transmitting the rendered image data to the first processor module when the rendered image data is different from the existent rendered image data used to display the existent image page on the electronic paper display panel, and not transmitting the rendered image data to the first processor module when the rendered image data is sufficiently similar to the existent rendered image data used to display the existent image page on the electronic paper display panel.

10. The electronic paper display system according to claim 1, wherein the second processor module is configured to store image content data or rendered image data.

11. The electronic paper display system according to claim 1, wherein the first processor module is configured to receive and store existent rendered image data corresponding with the existent image page currently displayed on the electronic paper display panel, and the second processor module is configured to receive and store previously rendered image data corresponding with image pages previously displayed on the electronic paper display panel.

12. The electronic paper display system according to claim 1, wherein the electronic paper display system is configured to periodically power down for a power-down period subsequent to having transmitted the triggering signal and completed the execution of the image transmission decision, the power-down period ending with the transmission of the next triggering signal.

13. The electronic paper display system according to claim 1, wherein the image content represents a monthly calendar, a weekly calendar, an agenda, or a clock.

14. A process for displaying an image page on an electronic paper display panel containing a housing, wherein the process comprises:
receiving a command input at an input device to retrieve image content in the form of image content data from an image content source;
sending the command input from the input device to a second processor module located remotely to the housing;
retrieving, using the remotely located second processor module, the image content data from the image content source;
generating rendered image data, using the remotely located second processor module, from the retrieved image content data;
sending the rendered image data, using the remotely located second processor module, to a first processor module located in the housing;
sending the rendered image data, using the first processor module located in the housing, to a display driver module that is coupled to the electronic paper display panel; and
operating the display driver module to display the rendered image data on the image page on the electronic paper display panel.

15. The process according to claim 14, wherein the process further comprises sending the retrieved image content in the form of image content data to the input device for display in the form of a displayed image on a display of the input device.

16. The process according to claim 14, wherein the process further comprises modifying the received image content due to receiving additional user input at the input device, and sending modified image content data to the remotely located second processor module to generate modified rendered image data, sending the modified rendered image data content, using the remotely located second processor module, to the first processor module located in the housing; sending the modified rendered image data content, using the first processor module located in the housing, to the display driver module; and operating the display driver module to display an image page corresponding with the modified rendered image data on the electronic paper display panel.

17. The process according to claim 14, wherein the process further comprises sending the received image content in the form of image data content via the remotely located second processor module to at least one second input device for displaying the image data content in the form of a displayed image on an input display of the at least one second input device.

18. The process according to claim 14, wherein the process further comprises comparing the rendered image data with existent rendered image data used to display an existent image page on the electronic paper display panel, and operating the second processor module to then execute a rendered image data transmission decision comprising transmitting the rendered image data to the first processor module when the rendered image data is different from the existent rendered image data used to display the existent image page on the electronic paper display panel, and not transmitting the rendered image data to the first processor module when the rendered image data is sufficiently similar to the existent rendered image data used to display the existent image page on the electronic paper display panel.

19. The process according to claim 14, wherein the process further comprises receiving user input at the input device for generating an authentication token to access the image content source or the second processor module, issuing the authentication token via the image content source or the second processor module to the input device, and taking action on at least one input command received at the second processor module or the image content source from the input device when the input commands are accompanied with the authentication token.

20. The process according to claim 19, wherein the at least one input command is a command to modify the displayed image on the image page on the electronic display paper panel.
